(19) United States
(12) Patent Application Publication
(10) Pub. No.: US 2014/0340536 A1
(43) Pub. Date: Nov. 20, 2014

(54) Image Stabilization

(71) Applicant: Nokia Corporation, Espoo (FI)

(72) Inventor: Herman Scherling, Kokkedal (DE)

(21) Appl. No.: 14/344,996

(22) PCT Filed: Sep. 15, 2011
(86) PCT No.: PCT/IB2011/054040

§ 371 Date: Mar. 14, 2014

(51) Int. Cl. H04N 5/232; G02B 27/64

(52) U.S. Cl. CPC H04N 5/2328; G02B 27/646
USPC 348/208.8; 348/208.11

(57) ABSTRACT

Apparatus, methods and computer programs are provided an apparatus includes one or more reflectors configured to divide incoming light, received via an aperture, between at least first and second image sensors by reflecting a portion of the incoming light towards the first image sensor and a portion of the incoming light towards the second image sensor; and at least one actuator configured to move at least a portion of the one or more reflectors in order to compensate for movement of the apparatus during exposure of the first and second image sensors.

### TECHNOLOGICAL FIELD

Embodiments of the present invention relate to image stabilization. In particular, they relate to image stabilization in a camera comprising at least two image sensors.

### BACKGROUND

When an image sensor of a camera is exposed to light, movement of the camera (for example, due to user handshake) may result in blurring in the resultant image. Image stabilization may be used to prevent such blurring. In some image stabilization techniques, a lens is moved orthogonally to its optical axis to compensate for camera movement during exposure. In other image stabilization techniques, the image sensor of the camera is moved during exposure to compensate for camera movement.

### BRIEF SUMMARY

According to some, but not necessarily all, embodiments of the invention, there is provided an apparatus, comprising: one or more reflectors configured to divide incoming light, received via an aperture, between at least first and second image sensors by reflecting a portion of the incoming light towards the first image sensor and a portion of the incoming light towards the second image sensor; and at least one actuator configured to move at least a portion of the one or more reflectors in order to compensate for movement of the apparatus during exposure of the first and second image sensors.

According to some, but not necessarily all, embodiments of the invention, there is provided a method, comprising: moving at least a portion of one or more reflectors, configured to divide incoming light received via an aperture between at least first and second image sensors by reflecting a portion of the incoming light towards the first image sensor and a portion of the incoming light towards the second image sensor, in order to compensate for movement of the apparatus during exposure of the first and second image sensors.

According to some, but not necessarily all, embodiments of the invention, there is provided an apparatus, comprising: reflecting means for dividing incoming light, received via an aperture, between at least first and second image sensors by reflecting a portion of the incoming light towards the first image sensor and a portion of the incoming light towards the second image sensor; and means for moving at least a portion of the reflecting means in order to compensate for movement of the apparatus during exposure of the first and second image sensors.

According to some, but not necessarily all, embodiments of the invention, there is provided an apparatus, comprising: at least one processor; and at least one memory storing a computer program comprising computer program instructions configured, working with the at least one processor, to cause the apparatus to perform at least the following: controlling movement of one or more reflectors, configured to divide incoming light received via an aperture between at least first and second image sensors by reflecting a portion of the incoming light towards the first image sensor and a portion of the incoming light towards the second image sensor, in order to compensate for movement of the apparatus during exposure of the first and second image sensors.

According to some, but not necessarily all, embodiments of the invention, there is provided a method, comprising: controlling movement of one or more reflectors, configured to divide incoming light received via an aperture between at least first and second image sensors by reflecting a portion of the incoming light towards the first image sensor and a portion of the incoming light towards the second image sensor, in order to compensate for movement of the apparatus during exposure of the first and second image sensors.

According to some, but not necessarily all, embodiments of the invention, there is provided a non-transitory computer readable medium storing a computer program comprising computer program instructions that, when performed by at least one processor, cause at least the following to be performed: controlling movement of one or more reflectors, configured to divide incoming light received via an aperture between at least first and second image sensors by reflecting a portion of the incoming light towards the first image sensor and a portion of the incoming light towards the second image sensor, in order to compensate for movement of the apparatus during exposure of the first and second image sensors.

According to some, but not necessarily all, embodiments of the invention, there is provided an apparatus, comprising: means for controlling movement of one or more reflectors, configured to divide incoming light received via an aperture between at least first and second image sensors by reflecting a portion of the incoming light towards the first image sensor and a portion of the incoming light towards the second image sensor, in order to compensate for movement of the apparatus during exposure of the first and second image sensors.

### BRIEF DESCRIPTION

For a better understanding of various examples of embodiments of the present invention, reference will now be made by way of example only to the accompanying drawings in which:

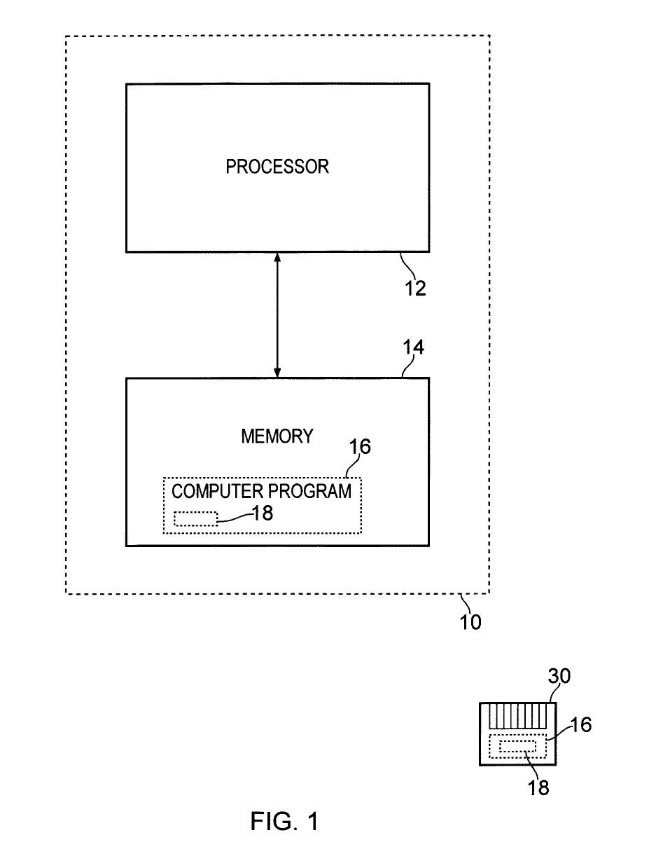

FIG. 1 is a schematic of an apparatus such as a chip or chipset;

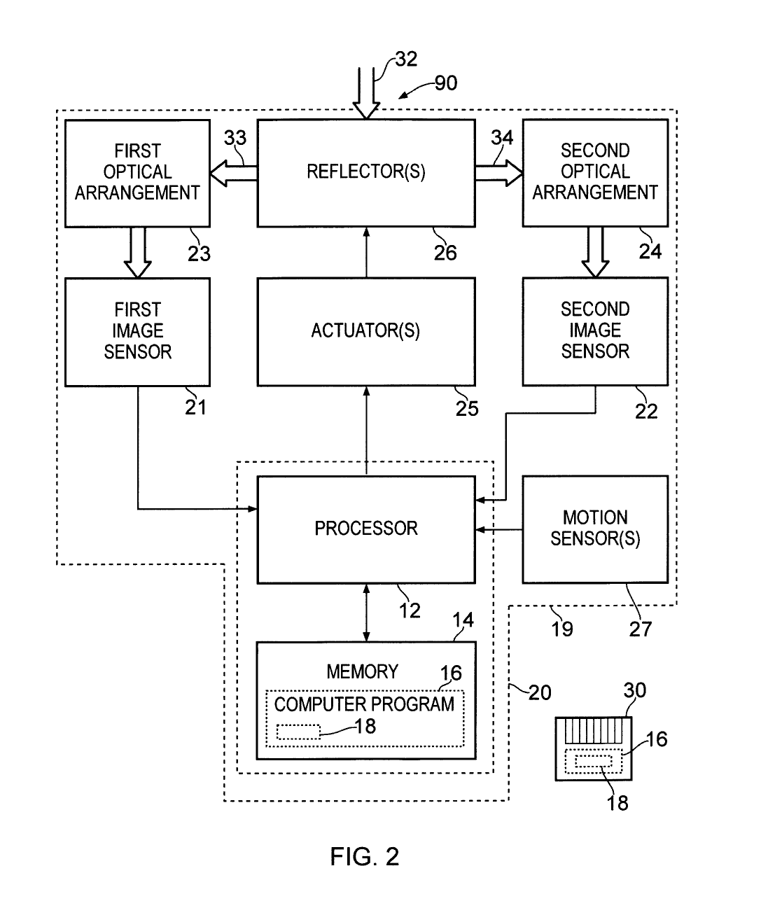

FIG. 2 is a schematic an apparatus such as a camera;

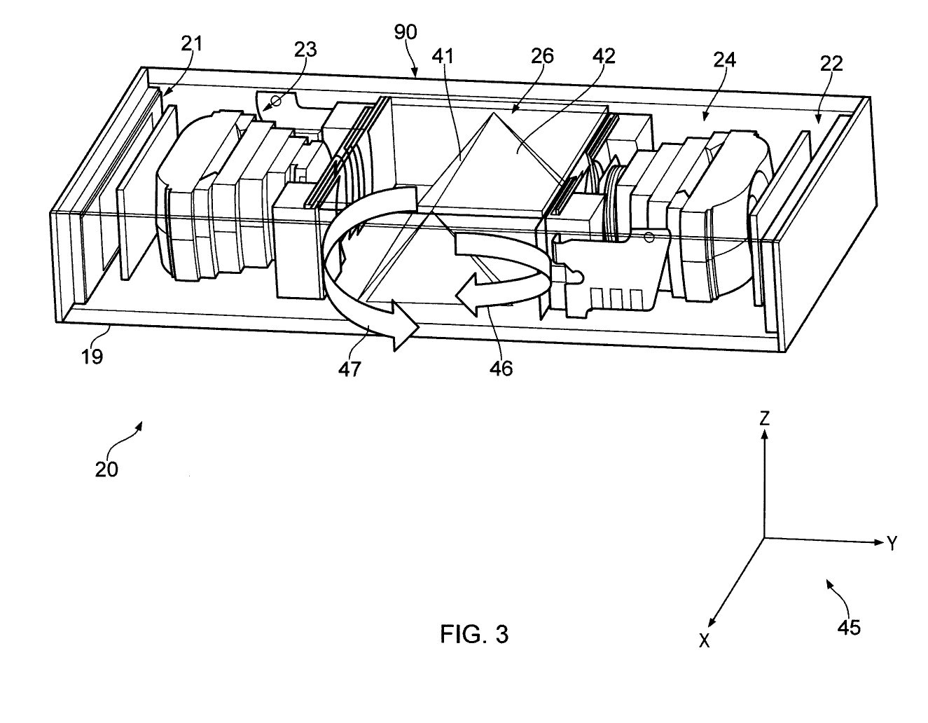

FIG. 3 illustrates an apparatus that comprises two image sensors and a movable reflector in the form of a triangular prism;

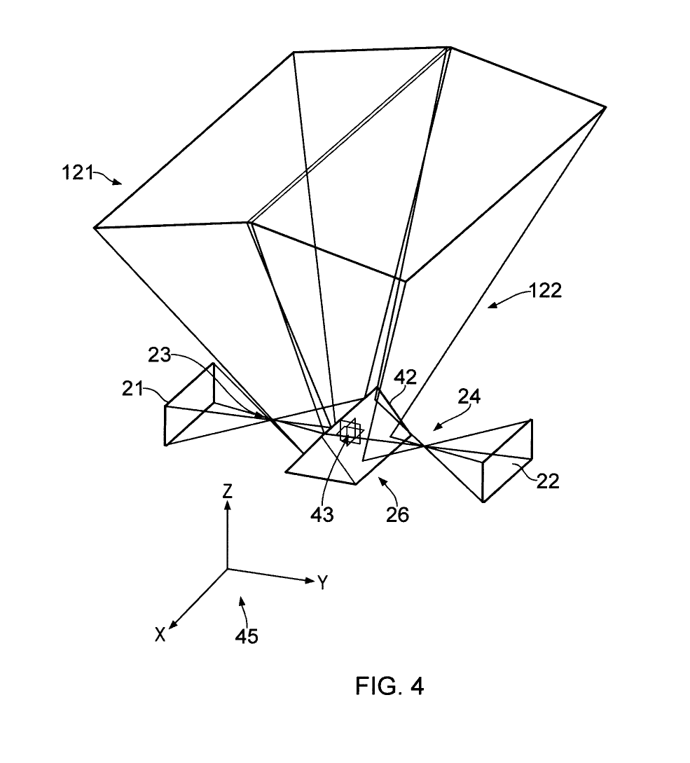

FIG. 4 illustrates a perspective view of the viewing cones of the two image sensors;

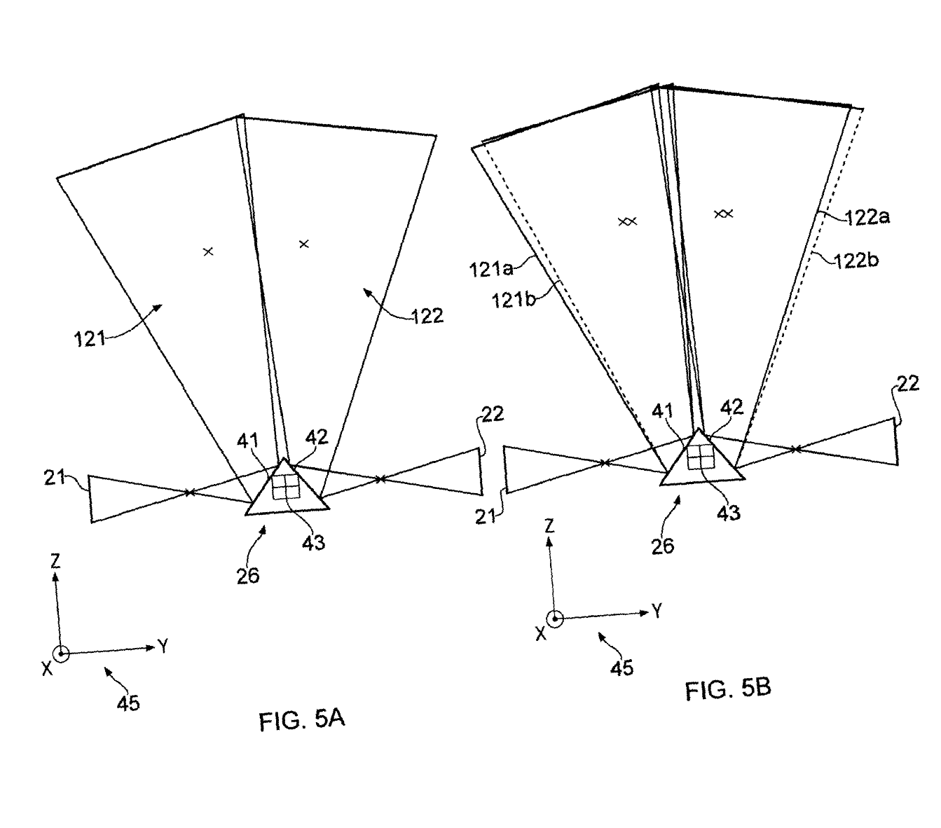

FIG. 5A illustrates the viewing cones of the two image sensors, as viewed along the x-axis, prior to rotation of the reflector about the x-axis;

FIG. 5B illustrates the viewing cones of the two image sensors, as viewed along the x-axis, before and after rotation of the reflector about the x-axis;

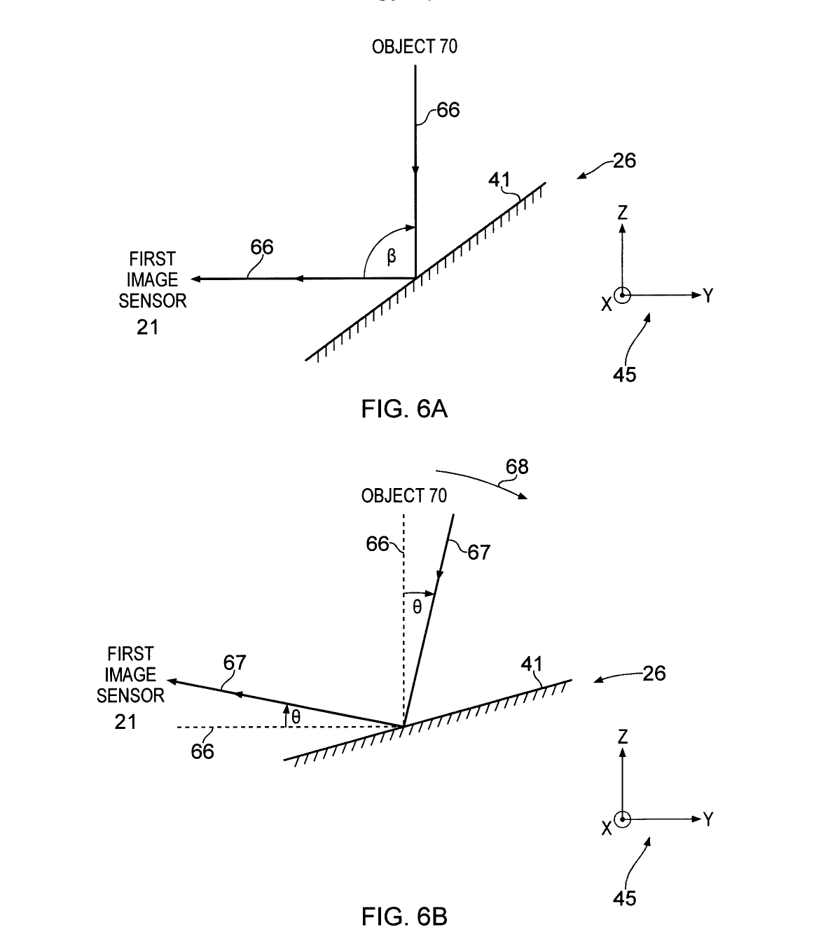

FIG. 6A is a schematic illustrating light being reflected by the reflector towards the first image sensor prior to rotation of the apparatus;

FIG. 6B is a schematic illustrating light being reflected by the reflector towards the first image sensor after rotation of the apparatus, and prior to rotation of the reflector;

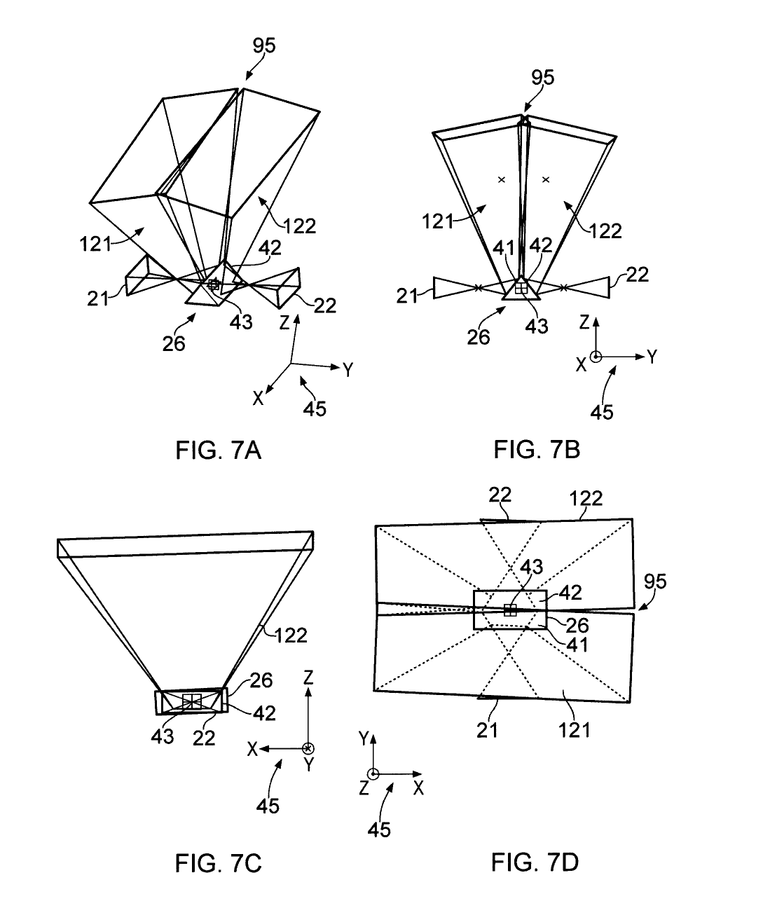

FIG. 7A illustrates a perspective view of the viewing cones of the two image sensors following rotation of the apparatus about the y-axis;

FIG. 7B illustrates the viewing cones of the two image sensors, as viewed along the x-axis, after rotation of the apparatus about the y-axis;

FIG. 7C illustrates a viewing cone of the one of the image sensors, as viewed along the y-axis, after rotation of the apparatus about the y-axis;

FIG. 7D illustrates the viewing cones of the two image sensors, as viewed along the z-axis, after rotation of the apparatus about the y-axis;

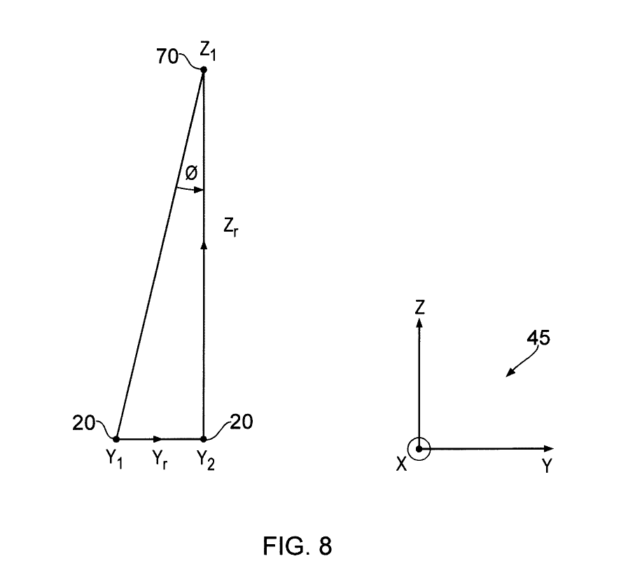

FIG. 8 is a schematic illustrating translational movement of the apparatus along the y-axis;

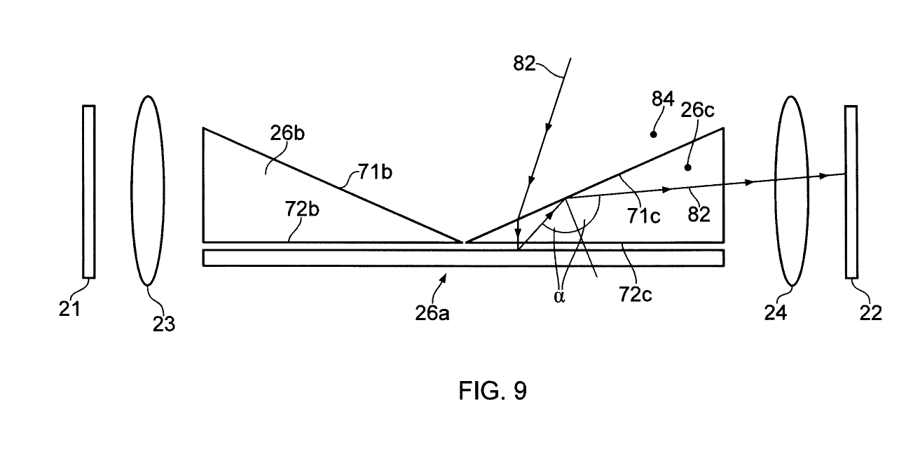

FIG. 9 illustrates embodiments of the invention in which two triangular prisms and a micro-mirror array are used to direct incoming light; and

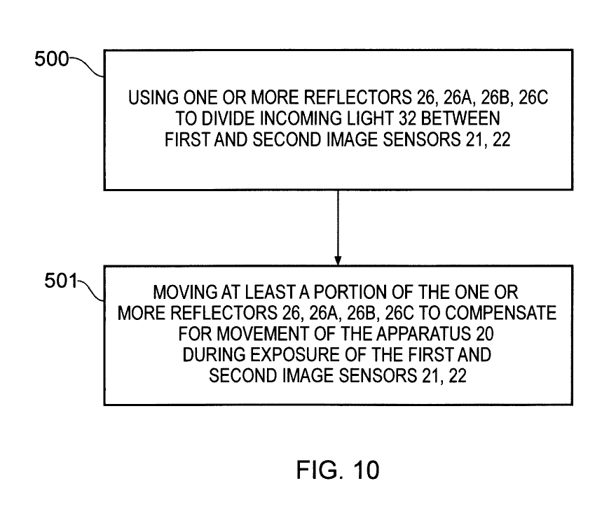

FIG. 10 illustrates a method.

### DETAILED DESCRIPTION

The figures illustrate an apparatus 20, comprising: one or more reflectors 26, 26a 26b, 26c configured to divide incoming light 32, received via an aperture 90, between at least first and second image sensors 21, 22 by reflecting a portion 33 of the incoming light 32 towards the first image sensor 21 and a portion 34 of the incoming light 32 towards the second image sensor 22; and at least one actuator 25 configured to move at least a portion of the one or more reflectors 26, 26a, 26b, 26c in order to compensate for movement of the apparatus 20 during exposure of the first and second image sensors 21, 22.

FIG. 1 illustrates a schematic of an apparatus 10 comprising at least one processor 12 and at least one memory 14. The apparatus 10 may, for example, be a chip or a chipset. Although a single processor 12 and a single memory 14 are illustrated in FIG. 1, in some implementations of the invention more than one processor 12 and/or more than one memory 14 is provided.

The processor 12 is configured to read from and write to the memory 14. The processor 12 may also comprise an output interface via which data and/or commands are output by the processor 12 and an input interface via which data and/or commands are input to the processor 12.

Although the memory 14 is illustrated as a single component it may be implemented as one or more separate components some or all of which may be integrated/removable and/or may provide permanent/semi-permanent/dynamic/cached storage.

The memory 14 stores computer program instructions 16 that control the operation of the apparatus 10 when loaded into the processor 12. The computer program instructions 16 provide the logic and routines that enables the apparatus 10/20 to perform the methods illustrated in FIG. 10. The processor 12 by reading the memory 14 is able to load and execute the computer program instructions 16.

The computer program instructions 16 may arrive at the apparatus 10/20 via any suitable delivery mechanism 30. The delivery mechanism 30 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program instructions 16. The delivery mechanism 30 may be a signal configured to reliably transfer the computer program instructions 16. The apparatus 10/20 may propagate or transmit the computer program instructions 16 as a computer data signal.

FIG. 2 illustrates a schematic of a further apparatus 20. The apparatus 20 may, for example, be a camera. In some embodiments of the invention, the apparatus 20 may be hand portable and may have further functionality. For example, the apparatus 20 may be configured to operate as a mobile telephone, a tablet computer, a games console and/or a portable music player.

The apparatus 20 illustrated in FIG. 2 comprises first and second image sensors 21, 22, first and second optical arrangements 23, 24, one or more actuators 25, one or more reflectors 26, one or more motion sensors 27 and the apparatus 10 illustrated in FIG. 1. The elements 12, 14 and 21 to 27 are operationally coupled and any number or combination of intervening elements can exist (including no intervening elements). The elements 12, 14 and 21 to 27 may be co-located within a housing 19.

The one or more motion sensors 27 may, for example, comprise one or more accelerometers and one or more gyroscopes. The processor 12 may, for example, be configured to use inputs from the motion sensor(s) 27 to determine whether the apparatus 20 has moved, the direction in which the apparatus 20 has moved, the speed at which the apparatus 20 has moved and the acceleration of the apparatus 20.

The one or more actuators 25 are configured to move at least a portion of the reflector(s) 26 via a mechanical coupling to the reflector(s) 26. At least one of the actuators 25 might be part of a micro mirror array. The processor 12 is configured to control the position of at least a portion of the reflector(s) 26 using the actuator(s) 25. The control may depend upon inputs received from the motion sensor(s) 27. In some embodiments of the invention the processor 12 may, for example, control the actuator(s) 25 via drive circuitry.

The one or more reflectors 26 are configured to divide incoming light 32, received via an aperture 90 in the housing 19 of the apparatus 20, between the first and second image sensors 21, 22. A portion 33 of the incoming light 32 is reflected by the reflector(s) 26 towards the first image sensor 21 and a portion 34 of the incoming light 32 is reflected by the reflector(s) 26 towards the second image sensor 22. This is schematically illustrated in FIG. 2, where a portion 33 of light is directed towards the first image sensor 21 via a first optical arrangement 23 and a portion 34 of light is directed towards the second image sensor 22 via a second optical arrangement 24. Each of the first and second optical arrangements 23, 24 comprises one or more optical devices. For example, each optical arrangement 23, 24 may be or comprise a lens.

Each portion 33, 34 of light conveys a different optical image. There may be an overlap between the optical images. This will be explained in further detail below.

The first and second image sensors 21, 22 may, for example, be charge coupled devices (CODs), complementary metal-oxide-semiconductor (CMOS) sensors or any other type of image sensor. They are configured to convert incident light (that is, an incident optical image) into an electronic signal. The processor 12 is configured to read the electronic signals from the image sensors 21, 22 and store them as data in the memory 14. In some embodiments of the invention, the processor 12 is configured to stitch the images provided by the image sensors 21, 22 together, at the overlap region, to form a single image.

FIG. 3 illustrates an example of an implementation of the apparatus 20 illustrated schematically in FIG. 3. Cartesian co-ordinate axes 45 are illustrated in FIG. 3 to enable the reader to orientate FIG. 3 relative to the other figures.

In the example illustrated in FIG. 3, light enters the housing 19 of the apparatus 20 in the −z direction via the aperture 90. In this embodiment, the one or more reflectors 26 illustrated in FIG. 2 are provided by a single reflector in the form of a triangular prism. The reflector 26 has first and second reflective surfaces 41, 42 which are angled with respect to one another and meet at the apex of the triangular prism.

The reflective surfaces 41, 42 in the illustrated example are substantially flat. However, in other examples, the reflective surfaces 41, 42 may have a spherical or an aspherical curvature.

The first and second optical arrangements 23, 24 each comprise multiple lenses in the illustrated embodiment. The first optical arrangement 23 is positioned between the first image sensor 21 and the reflector 26. The second optical arrangement 24 is positioned between the second image sensor 22 and the reflector 26. The first and second image sensors 21, 22 face in opposing directions in this example. The first image sensor 21 faces in the +y direction, and the second image sensor 22 faces in the −y direction.

In this example, the actuator 25 (not shown in FIG. 3) is configured to move (the whole of) the reflector 26 by rotating it within the housing 19. The actuator 25 may, for example, be coupled to the reflector 26 at the base of the triangular prism or within the body of the prism. The reflector 26 rotates relative to the aperture 90, the housing 19, the first and second optical arrangements 23, 24 and the first and second image sensors 21, 22.

The reflector 26 may, for example, rotate in one, two or three dimensions. The axes about which the reflector 26 rotates may pass through the reflector 26. Consider a situation in which the origin of the Cartesian co-ordinate axes 45 is positioned within the body of the reflector 26. Each of the x, y and z axes may represent an axis of rotation. The arrow labelled with the reference numeral 47 in FIG. 3 represents rotation about the z-axis. The arrow labelled with the reference numeral 46 represents rotation about the x-axis. The reflector 26 may also rotate about the y-axis, although FIG. 3 does not include an arrow illustrating such movement.

In use, light from an object/scene enters the housing 19 via the aperture 90. The reflector 26 divides the incoming light between the first and second image sensors 21, 22. In this example, the first reflective surface 41 reflects incoming light in a first (−y) direction towards the first image sensor 21 and the second reflective surface 42 reflects incoming light in second (+y) direction that is substantially opposite to the first direction.

Initially, when the first and second image sensors 21, 22 are exposed to capture images, the reflector 26 is in its “default position”. The apparatus 20 is configured to “lock-on” to an object/scene being imaged during exposure of the first and second image sensors 21, 22. That is, if the apparatus 20 moves during exposure of the first and second image sensors 21, 22, the processor 12 controls the actuator(s) 25 to move the reflector 26 such that light from the object/scene continues to be directed towards the image sensors 21, 22. Movement of the reflector 26 compensates for the movement of the apparatus 20 (which may, for example, be due to user handshake) and changes the direction from incoming light is reflected by the reflector 26 towards the first and second image sensors 21, 22, relative to the position of the apparatus 20.

In this embodiment, since the first and second reflective surfaces 41, 42 are moved simultaneously, the direction from which incoming light is directed towards the first image sensor 21 and the direction from which incoming light is directed towards the second image sensor 22 are changed simultaneously.

FIG. 4 illustrates a perspective view of the viewing cones 121, 122 of the first and second image sensors 21, 22. The first viewing cone 121 represents the volume that is “seen” by the first image sensor 21 and the second viewing cone 122 represents the volume that is “seen” by the second image sensor 22.

FIG. 4 illustrates the reflector 26 when it is in its default position. In this position, the first and second viewing cones 121, 122 overlap. This means that there will be an overlap in the images formed by the first and second image sensors 21, 22, enabling them to be stitched together by the processor 12 to form a single, continuous image.

For simplicity, the first and second optical arrangements 23, 24 are illustrated in FIG. 4 as points. The origin of the Cartesian co-ordinate axes 45 is indicated by the reference numeral 43. The axes 45 are not illustrated as being in that position in FIG. 4 for clarity reasons.

FIG. 5A illustrates the viewing cones 121, 122 of the first and second image sensors 21, 22, as viewed along the x-axis, when the reflector 26 is in its default position. The first viewing cone 121 overlaps the second viewing cone 122.

FIG. 5B illustrates the viewing cones 121a, 122a of the first and second image sensors 21, 22 when the reflector 26 is in its default position, and the viewing cones 121b, 122b after rotation of the apparatus 20 about an object/scene being imaged. In the illustrated example, the apparatus is rotated by 2°, and the reflector 26 of the apparatus is rotated about the x-axis by roughly 1°.

It can be seen from FIG. 5B that when the reflector 26 is rotated about the x-axis by around 1°, the shape of the viewing cones 121a, 121b, 122a, 122b remains roughly the same and the overlap between the viewing cones 121b, 122b is maintained after rotation.

FIG. 6A is a schematic illustrating a light ray 66 being reflected by the reflector 26 towards the first image sensor 21 when the reflector 26 is in its default position. The light ray emanates from an object/scene 70 and is reflected through an angle R by the first surface 41 of the reflector 26.

FIG. 6B is a schematic that illustrates a situation in which the apparatus 20 has been rotated about the x-axis by an angle θ and the reflector 26 has not yet been moved by the processor 12. The arrow 68 illustrates the direction of movement of the apparatus 20 (and also the first reflecting surface 41 and the first image sensor 21). The dotted line 66 illustrates the previous path of the light ray 66 that was being reflected in FIG. 6A.

FIG. 6B illustrates a situation where, after movement of the apparatus 20, the direction from which light is reflected by the reflecting surface 41 has not changed relative to the position of the apparatus 20. That is, incoming light is still being reflected by the reflector 26 at an angle of β°. This is illustrated by the light ray 67.

This leads to the object/scene 70 no longer being imaged on the same position on the first image sensor 21 (if at all), causing significant image blurring.

Advantageously, in embodiments of the invention, the processor 12 “locks on” and maintains the object/scene 70 at the same position on the image sensor 21. In this regard, the processor 12 receives inputs from the motion sensor(s) 27 that characterize the movement of the apparatus 20. As the apparatus 20 moves, the processor 12 uses these inputs to control the movement of the reflector 26 using the actuator(s) 25. In this case, the processor 12 rotates the reflector 26 in a direction which is opposite to the direction in which the apparatus 20 moves.

The reflector 26 is rotated by an angle of θ/2, in the direction opposite to that indicated by arrow 68, in order to compensate for the movement of the apparatus 20. This maintains the object/scene 70 at the same position on the first image sensor 21 as the apparatus 20 is moved.

For example, the light ray 66 is reflected by β by the first reflecting surface 41 of the reflector 26 in FIG. 6A, prior to movement of the apparatus 20. If the apparatus 20 is rotated by 2° to reach the position illustrated in FIG. 6B, in order for light from the object/scene 70 to be reflected onto the same portion of the first image sensor 21 as was the case in FIG. 6A, it must be reflected at an angle of β-2° by the reflector 26. The angle of incidence and the angle of reflection for the reflecting surface 41 are the same at (β−2)°/2, so the processor 12 causes the reflector 26 to rotate by 1° in a direction which is opposite to the direction of movement of the apparatus 20.

FIG. 7A illustrates a perspective view of the viewing cones 121, 122 of the first and second image sensors 21, 22 after the reflector 26 has been rotated about the y-axis. In this example, the apparatus 20 has been rotated by 2° about the y-axis. FIGS. 7B, 7C and 7D illustrate the same situation from different viewpoints.

It can be seen from FIGS. 7A, 7B and 7D, in a situation where the reflective surfaces 41, 42 are flat, this movement of the reflector 26 causes a gap 95 to open between the first and second viewing cones 121, 122. In the illustrated examples, the gap 95 is present irrespective of the distance at which an object is imaged. A consequence of this is that images captured simultaneously by the first and second image sensors 21, 22 cannot be stitched together to form a single, continuous image. A discontinuous region would be present in the stitched image corresponding with the gap 95 between the first and second viewing cones 121, 122.

The apparatus 20 may be configured to prevent this from happening in two ways. In some embodiments, the range of movement of the reflector 26 is limited. That is, the processor 12, actuator 25 and/or the reflector 26 may be configured such that whatever the position of the reflector 26, there is no gap 95 between the first and second viewing cones 121, 122 within a certain range of focal distances. Alternatively or additionally, the first and second reflecting surfaces 41, 42 may each be micro-mirror arrays, enabling the shape of each surface 41, 42 to change in order to vary the shape and/or the position of the viewing cones 121, 122. It may also be possible to prevent the gap 95 from appearing between the first and second viewing cones 121, 122 by using reflective surfaces 41, 42 that are not flat (for example, curved).

Embodiments of the invention may compensate for translational movement of the apparatus 20 during exposure of the first and second image sensors 21, 22. FIG. 8 illustrates a schematic in which an object/scene 70, at a position z₁, is being imaged by the apparatus 20. During exposure of the first and second image sensors 21, 22, the apparatus 20 is moved by a distance yᵣ from a first position y₁ to a second position y₂. When the apparatus 20 is in the second position y₂, it is a distance zᵣ from the object/scene 70.

When the apparatus 20 moves from y₁ to y₂, its angular movement Φ is equal to inverse tan (yᵣ/zᵣ). In order to compensate for the movement of the apparatus 20, the processor 12 may control the actuator(s) 25 to rotate the reflector 26 by φ/2 in a direction that is opposite to the angular movement φ of the apparatus 20. By way of example, if the zᵣ is 2 meters and yᵣ is 5 millimeters, angular movement φ is 0.14°, and the processor 12 may rotate the reflector 26 by 0.07°.

FIG. 9 illustrates an alternative embodiment of the invention in which the apparatus 20 comprises three separate reflectors rather than the reflector 26 illustrated in FIG. 3 to FIG. 7D. The three separate reflectors are first and second triangular prisms 26b 26c and a separate micro-mirror array 26a.

In this example, the cross-section of each of the first and second triangular prisms 26b, 26c is a right angled triangle. The first and second triangular prisms 26b, 26c are situated above the micro-mirror array 26a. Each triangular prism 26b, 26c has a lower surface 72b, 72c that is substantially parallel with the surface of the micro-mirror array 26a, when the micro-mirror array 26a is in its default position (substantially flat). Each triangular prism 26b, 26c has an upper surface 71b, 71c that is angled with respect to its lower surface 72b, 72c.

FIG. 9 illustrates a light ray 82 being directed towards the second image sensor 22. The light 82 enters the second triangular prism 26c from a medium 84 having a lower refractive index than the second triangular prism 26c. The medium may, for example, be air.

The light 82 is refracted as it enters the upper angled surface 71c of the triangular prism. It then passes through the lower, flat surface 72c of the second triangular prism 26c prior to being reflected by the micro-mirror array 26a. The micro-mirror array 26 reflects the light 82 towards the upper angled surface 71c of the second triangular prism 26c. The light 82 undergoes total internal reflection at the upper angled surface 71c and is reflected towards the second image sensor 22, at an angle of 2α.

It will be appreciated that light is reflected towards the first image sensor 21 by the micro-mirror array 26a the first triangular prism 26b in a similar manner to that described above in relation to the second image sensor 22.

In the FIG. 9 embodiment, the first and second triangular prisms 26b, 26c may be fixed in place within the housing 19 of the apparatus 20. The processor 12 is configured to compensate for movement of the apparatus 20 during exposure of the image sensors 21, 22 by controlling actuators 25 of the micro-mirror array 26a to adjust the position of at least a portion of its surface. That way, the processor 12 can change the direction from which incoming light is reflected towards the image sensors 21, 22, relative to the position of the apparatus 20 and “lock-on” to a particular object or scene being captured.

FIG. 10 illustrates a method according to embodiments of the invention. At block 500 of FIG. 10, one or more reflectors 26, 26a, 26b, 26c divide incoming light 32, received via an aperture 90, between at least first and second image sensors 21, 22 by reflecting a portion 33 of the incoming light towards the first image sensor 21 and a portion 34 of the incoming light 32 towards the second image sensor 22.

The processor 12 initiates exposure of the first and second image sensors 21, 22 and, during exposure, the apparatus 20 is moved (for example, due to user handshake).

At block 501 of FIG. 10, a processor 12 controls one or more actuators 25 to move at least a portion of the one or more reflectors 26, 26a, 26b, 26c to compensate for the movement of the apparatus 20 during exposure of the first and second image sensors 21, 22.

In summary, embodiments of the invention provide an image stabilization solution for an apparatus 20 having at least two image sensors 21, 22. The apparatus 20 of embodiments of the invention potentially provides a more compact arrangement than a more conventional arrangement where a single image sensor is aligned with an aperture. This is particularly useful in mobile telephones, for example, where space within the housing is at a premium.

Advantageously, in embodiments of the invention, the one or more reflectors 26, 26a, 26b, 26c of the apparatus 20 may compensate for unwanted movement of the apparatus 20. In at least some embodiments, the reflector(s) 26, 26a, 26b, 26c may compensate for movement of multiple image images sensors 21, 22 substantially simultaneously.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

One or more blocks illustrated in the FIG. 10 may represent one or more steps in a method and/or sections of code in the computer program 16. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example, the reflector 26 illustrated in FIG. 3 need not be a triangular prism. Instead it may, for example, have an inverted v shape (̂).

The embodiments of the invention illustrated in the figures relate to an apparatus 10 comprising a reflector 26 having flat reflective surfaces 41, 42. As explained above, in some alternative embodiments of the invention, the reflective surfaces 41, 42 may have a spherical or an aspherical curvature. It will be appreciated by those skilled in the art that the viewing cone diagrams for these embodiments may be different to those in FIGS. 4, 5A, 5B and 7A to 7D.

In some embodiments, the apparatus 10 may not comprise any motion sensors 27. In these embodiments, the processor 12 may determine whether the apparatus 20 has moved (and the speed at which it has moved) by analysing images captured using an image sensor 21, 22 and determining the differences between them.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1-24. (canceled)

25. An apparatus, comprising:
one or more reflectors configured to divide incoming light, received via an aperture, between at least first and second image sensors by reflecting a portion of the incoming light towards the first image sensor and a portion of the incoming light towards the second image sensor; and
at least one actuator configured to move at least a portion of the one or more reflectors in order to compensate for movement of the apparatus during exposure of the first and second image sensors.

26. An apparatus as claimed in claim 25, wherein the movement of the at least a portion of the one or more reflectors is configured to change the direction from which incoming light is reflected towards the first image sensor, relative to the position of the apparatus, and the direction from which incoming light is reflected towards the second image sensor, relative to the position of the apparatus.

27. An apparatus as claimed in claim 26, wherein the direction from which incoming light is directed towards the first image sensor and the direction from which incoming light is directed towards the second image sensor are configured to change substantially simultaneously.

28. An apparatus as claimed in claim 25, wherein the portion of light reflected towards the first image sensor is directed in a first direction and the portion of light directed towards the second image sensor is directed in a second direction, substantially opposite to the first direction.

29. An apparatus as claimed in claim 25, wherein the one or more reflectors comprise at least first and second reflective surfaces.

30. An apparatus as claimed in claim 29, wherein the first reflective surface is configured to reflect a portion of incoming light towards the first image sensor, and the second reflective surface is configured to reflect a portion of incoming light towards the second image sensor.

31. An apparatus as claimed in claim 29, wherein the first reflective surface is angled relative to the second reflective surface.

32. An apparatus as claimed in claim 31, wherein the first and second reflective surfaces are part of a triangular prism.

33. An apparatus as claimed in claim 25, wherein the at least one actuator is configured to rotate the portion of the at least a portion of the one or more reflectors in order to compensate for movement of the apparatus during exposure of the first and second image sensors.

34. An apparatus as claimed in claim 25, wherein the one or more reflectors comprise a micro-mirror array.

35. An apparatus as claimed in claim 25, wherein the apparatus is a hand portable electronic apparatus that is configured to operate as a camera.

36. A method, comprising:
moving at least a portion of one or more reflectors, configured to divide incoming light received via an aperture between at least first and second image sensors by reflecting a portion of the incoming light towards the first image sensor and a portion of the incoming light towards the second image sensor, in order to compensate for movement of the apparatus during exposure of the first and second image sensors.

37. A method as claimed in claim 36, wherein the movement of the at least a portion of the one or more reflectors changes the direction from which incoming light is reflected towards the first image sensor, relative to the position of the apparatus, and the direction from which incoming light is reflected towards the second image sensor, relative to the position of the apparatus.

38. A method as claimed in claim 37, wherein the direction from which incoming light is directed towards the first image sensor and the direction from which incoming light is directed towards the second image sensor are changed substantially simultaneously.

39. A method as claimed in claim 36, wherein the portion of light reflected towards the first image sensor is directed in a first direction and the portion of light directed towards the second image sensor is directed in a second direction, substantially opposite to the first direction.

40. A method as claimed in claim 37, wherein the one or more reflectors comprise at least first and second reflective surfaces, wherein the first reflective surface reflects a portion of incoming light towards the first image sensor, and the second reflective surface reflects a portion of incoming light towards the second image sensor.

41. A method as claimed in claim 40, wherein the first reflective surface is angled relative to the second reflective surface.

42. A non-transitory computer readable medium storing a computer program comprising computer program instructions that, when performed by at least one processor, cause at least the following to be performed:
controlling movement of one or more reflectors, configured to divide incoming light received via an aperture between at least first and second image sensors by reflecting a portion of the incoming light towards the first image sensor and a portion of the incoming light towards the second image sensor, in order to compensate for movement of the apparatus during exposure of the first and second image sensors.
